(19) United States
(12) Patent Application Publication
(10) Pub. No.: US 2014/0086286 A1
(43) Pub. Date: Mar. 27, 2014

(54) DIVERSITY ANTENNA HOUSING

(71) Applicant: Rosemount Inc., Chanhassen, MN (US)

(72) Inventors: Brett Robert Morrison, Minnetrista, MN (US); Chad Michael McGuire, Shakopee, MN (US); Daniel Clifford Carlson, St. Paul, MN (US)

(73) Assignee: Rosemount Inc., Chanhassen, MN (US)

(21) Appl. No.: 13/628,516

(22) Filed: Sep. 27, 2012

(51) Int. Cl. H04B 7/06

(52) U.S. Cl. CPC H04B 7/061
USPC 375/219; 375/285

(57) ABSTRACT

A wireless device comprises a plurality of diverse antennas, an accelerometer configured to determine an orientation of the wireless device, and a processor. The processor is configured to initially select a primary link configuration based on the determined orientation of the wireless device. The primary link configuration designates one or more of the plurality of diverse antennas and one or more diverse antennas of another wireless device configured to transmit the payload messages. The processor is further configured to receive payload messages using the primary link configuration, record a received signal strength indication (RSSI) value for the received payload messages, and periodically test RSSI for alternative link configurations. The processor compares RSSI between the primary link configuration and the alternative link configuration, and revises the primary link configuration if the comparison indicates that the alternative link configuration RSSI is greater than primary link configuration RSSI.

### BACKGROUND

The present invention relates generally to wireless devices, and more particularly to an industrial process field device with a circuit card having a plurality of diverse integrated antennas selected for transmission and reception based on device orientation and received signal strength indication (RSSI) measurements.

The term “field device” covers a broad range of process management devices that measure and control parameters such as pressure, temperature, and flow rate. Many field devices include transceivers which act as communication relays between an industrial process variable sensor and a remote control or monitoring device such as a computer. The output signal of a sensor, for example, is generally insufficient to communicate effectively with a remote control or monitoring device. A field device bridges this gap by receiving communication from the sensor, converting this signal to a form more effective for longer distance communication (for example a modulated 4-20 mA current loop signal, or a wireless protocol signal), and transmitting the converted signal to the remote control or monitoring device.

Field devices are used to monitor and control a variety of parameters of industrial processes, including pressure, temperature, viscosity, and flow rate. Other field devices actuate valves, pumps, and other hardware of industrial processes. Each field device typically comprises a sealed enclosure containing actuators and/or sensors, electronics for receiving and processing sensor and control signals, and electronics for transmitting processed sensor signals so that each field device and industrial process parameter may be monitored remotely. Large scale industrial manufacturing facilities typically employ many field devices distributed across a wide area. These field devices usually communicate with a common control or monitoring device, allowing industrial processes to be centrally monitored and controlled. A variety of wireless network structures have been used for field devices, including hub-and-spoke networks (with and without hierarchical branching) and mesh networks.

Many kinds of wireless devices use multiple antennas with diverse positions and/or orientations for more robust signal reception and transmission. Signal strength and noise level in communication between two devices with diverse antenna arrays may vary between each antenna combination of the receiving and transmitting devices. Some wireless systems combine signals from multiple diverse antennas to form a single composite signal with diversity gain≈Σₖ₌₁^{N}1/k (assuming N independent Rayleigh distributed signals), while others utilize only one antenna at a time, selected to optimize signal strength or reduce noise. Systems that use only one antenna at a time for transmission or reception are popular for power limited devices such as devices operating on battery or scavenged power, to minimize power consumption during transmission and reception.

A variety of methods exist to select a single antenna for signal transmission and/or reception in diversity antenna systems. Some systems test RSSI or noise level only during a configuration mode, selecting the strongest or least noisy antenna and using that antenna for transmission and/or reception until returned manually to the configuration mode. Other systems test noise level using a selected antenna on a continuous or periodic basis, and automatically initiate a similar configuration mode whenever measured noise level exceeds a predetermined threshold. A few systems utilize device position to select transmission or reception antennas.

### SUMMARY

The present invention is directed toward a wireless device that comprises a plurality of diverse antennas, an accelerometer configured to determine an orientation of the wireless device, and a processor. The processor is configured to initially select a primary link configuration based on the determined orientation of the wireless device. The primary link configuration designates one or more of the plurality of diverse antennas and one or more diverse antennas of another wireless device configured to transmit the payload messages. The processor is further configured to receive payload messages using the primary link configuration, record a received signal strength indication (RSSI) value for the received payload messages, and periodically test RSSI for alternative link configurations. The processor compares RSSI between the primary link configuration and the alternative link configuration, and revises the primary link configuration if the comparison indicates that the alternative link configuration RSSI is greater than primary link configuration RSSI.

### BRIEF DESCRIPTION OF THE DRAWINGS

FIG. 1 is a perspective view of a field device according to the present invention.

FIG. 2 is a schematic block diagram of the field device of FIG. 1.

FIG. 3 is a schematic diagram of a wireless network including the field device of FIG. 1.

FIG. 4a is a flowchart of a method used by the field device of FIG. 1 to select antenna configurations.

FIG. 4b is a flowchart of an alternative method used by the field device of FIG. 1 to select antenna configurations.

### DETAILED DESCRIPTION

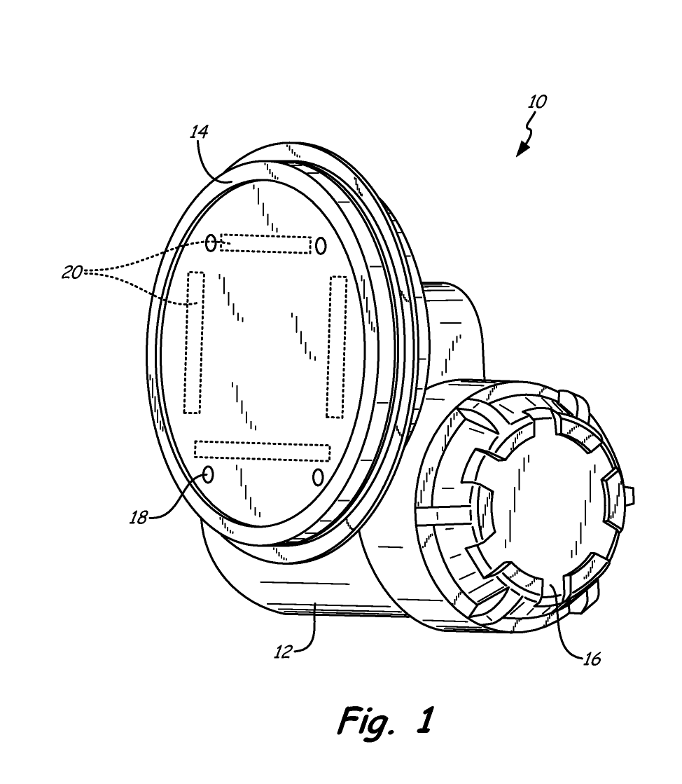

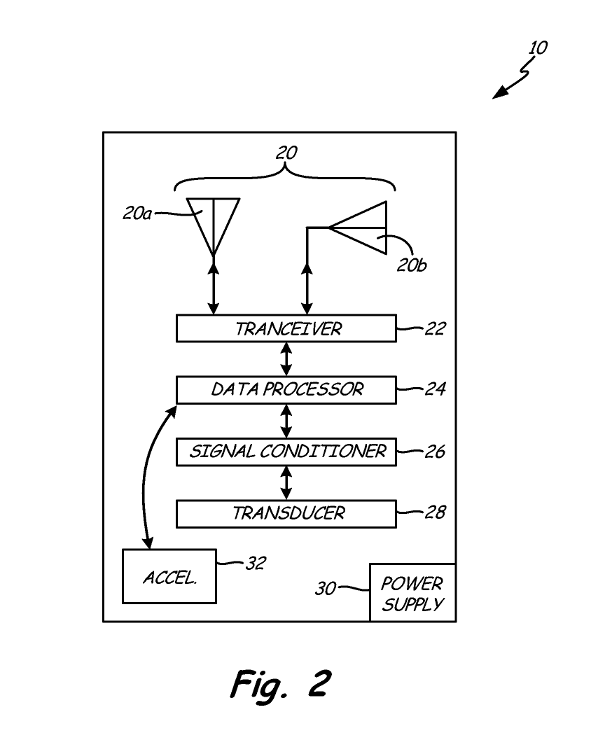

FIG. 1 is a perspective view of one possible embodiment of field device 10, comprising housing 12, plate section 14, sealed cover 16, mounting points 18, and antennas 20 (shown in phantom). Field device 10 is an industrial process field device that senses or actuates an industrial process parameter, as described in further detail below with respect to FIG. 2. Field device 10 may be connected to an external process transducer (not shown), or may include an internal transducer. Possible types of transducers include temperature, pressure, flow, and viscosity sensors, as well as pump, valve, and motor actuators. Field device 10 enables remote devices such as central process monitoring and control systems to wirelessly transmit and receive sensor data and/or commands to transducers wirelessly.

In the depicted embodiment, housing 12 is a rigid enclosure formed, for instance, from molded plastic resin. Housing 12 provides a sealed environment for data and signal processing electronics, transceivers, and antennas, as described below. Many industrial process applications take place in hostile or extreme environments which could be detrimental to electronics housed within housing 12. Housing 12 acts as a shield, protecting electronics from moisture, debris, and extreme changes in temperature and pressure. Plate section 14 is portion of housing 12 configured to enclose antennas 20. Antennas 20 are antennas of diverse angular orientation, and may be mounted on or formed within a circuit board housed in plate section 14 of housing 12. Antennas 20 may, for instance, be mounted along orthogonal axes in the plane of plate section 14. Plate section 14 may house other electronics in addition to antennas 20, including transceivers, data processors, and/or signal conditioners. Although antennas 20 are depicted as located within plate section 14, plate section 14 is only one example of a possible geometry of housing 12. Alternative embodiments of field device 10 may comprise housings of differing geometries without departing from the spirit of the present invention. Sealed cover 16 is a removable cover to housing 12. Sealed cover 16 and provides a debris-, water-, and/or airtight seal when locked in place (as shown), but may be removed to access an interior region of housing 12, e.g. to replace a battery or access interior electronics. Some embodiments of housing 12 may include multiple sealed covers 16, each of which provides access to a separate internal compartment of housing 12, e.g. to separate battery and electronics compartments. As depicted in FIG. 1, plate section 14 also serves as a base plate with mounting points 18 for securing field device 10 to or near an industrial process point. Mounting points 18 may, for instance, be screw or bolt attachment points used to affix housing 12 to an adjacent surface. Some embodiments of field device 10 may further comprise one or more wire conduits through housing 12 for power or signal transmission, e.g. to external transducers, energy scavenging systems, or grid power. Housing 12 may be configured to fit a battery or analogous power source.

Antennas 20 may take a variety of forms. As depicted in FIG. 1, antennas 20 are flat internal antennas which may, for instance, be mounted on or formed within a circuit board or printed wiring board. In other embodiments, antennas 20 may be external antennas which protrude from housing 12. Although FIG. 1 shows four distinct antennas 20, any plural number of diverse antennas 20 may be used.

FIG. 2 is a schematic block diagram of one embodiment of field device 10. FIG. 2 depicts antennas 20 (including antenna 20a and 20b), transceiver 22, data processor 24, signal conditioner 26, transducer 28, power supply 30, and accelerometer 32. Antennas 20 are antennas with diverse angular orientation, as described above, such that antenna 20a is oriented substantially orthogonally to antenna 20b. Although only two antennas 20 are depicted in FIG. 2, the present invention may be applied to any plural number of antennas 20. Antennas 20a and 20b may, for instance, be joined by a third antenna (not shown) orthogonal to one or both of them. Although orthogonal arrangements of antennas 20 provide the greatest angular diversity, non-orthogonal arrangements may be used with some geometries of housing 12.

In the depicted embodiment, transceiver 22 is multi-antenna transceiver with an integrated switch capable of sequentially servicing the plurality of antennas 20. Transceiver 22 is capable of both transmitting and receiving signals to remote devices, and may in some embodiments be capable of simultaneously utilizing more than one antenna 20. Transceiver 22 is further configured to provide data processor 24 with an RSSI measurement reflecting received signal strength at antennas 20.

In one embodiment, data processor 24 is a logic-capable device configured to receive and process sensor signals from transducer 28 and/or command signals from transceiver 24, as well as other signals for fault monitoring and diagnostics. Data processor 24 may, for instance, control transducer 28 to actuate an industrial parameter in response to commands received over antennas 20 and transceiver 22 from a remote device. Alternatively, data processor 24 may digitally filter and transmit sensor signals from transducer 28 to a remote device via transceiver 22 and antennas 20. Some embodiments of field device 10 may perform both sensing and actuating functions. Data processor 24 may also measure and record packet error rate of incoming messages.

In one embodiment, signal conditioner 26 is an electronics block configured to condition signals from transducer for processing by data processor 24, and/or condition commands from data processor 24 for reception at transducer 28. Signal conditioner 26 may include analog signal filters such as band-pass filters. Where appropriate, signal conditioner 26 may further comprise analog/digital conversion hardware (e.g. where transducer 28 is a sensor with analog output).

Transducer 28 is a sensor or actuator tied, in some embodiments, to a particular industrial process variable. Transducer 28 may, for instance, be an actuator for a flow valve, or a pressure, temperature, or fluid flow rate sensor. Although transducer 28 is depicted as a part of field device 10, some embodiments of transducer 28 may be external components connected to signal processor 26 by wire or cable. Some embodiments of field device 10 may include several transducers 28, which may monitor or actuate the same or different parameters.

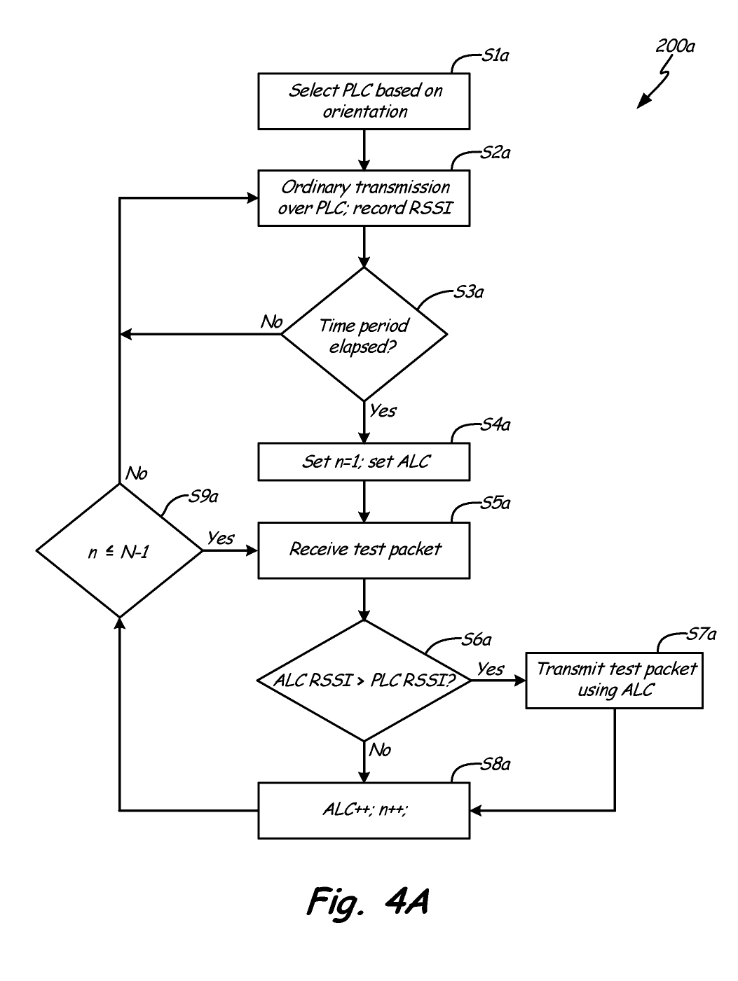

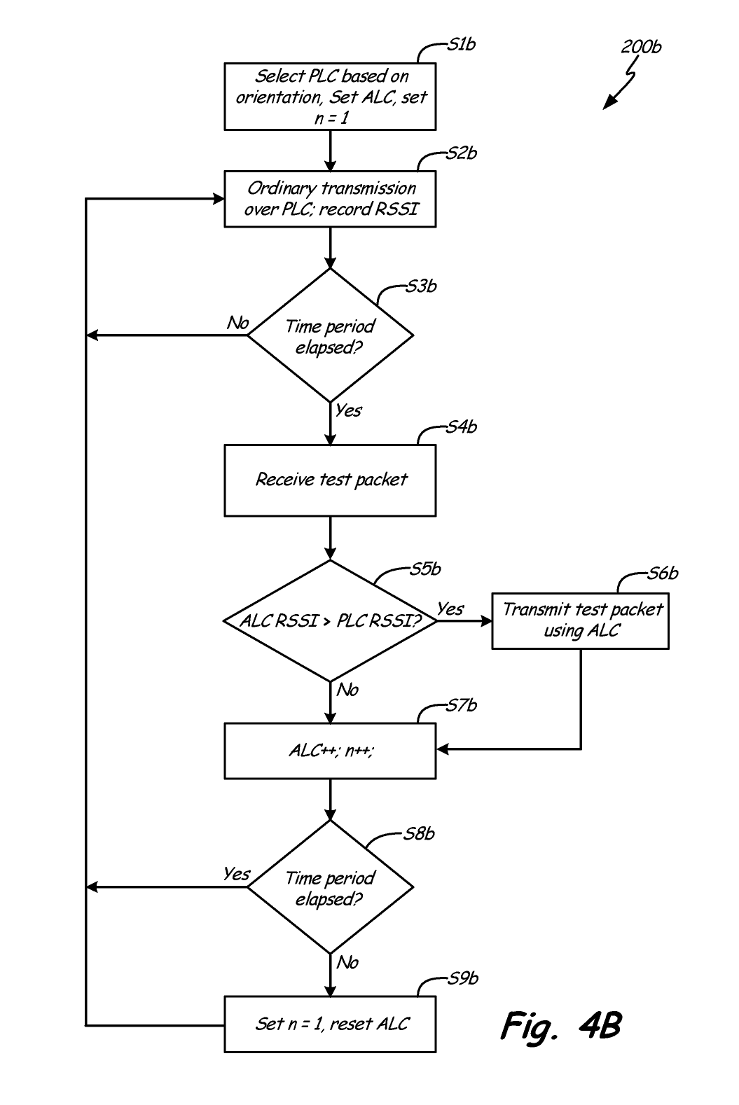

Power supply 30 provides power to all powered components of field device 12, including antennas 20, transceiver 22, data processor 24, and signal conditioner 26. Depending on the nature and location of transducer 28, power supply 30 may also power transducer 28. Power supply 30 may be a battery, supercapacitor, fuel cell, or other energy storage device. Alternatively, power supply 30 may be an energy harvesting system such as a vibrational or thermoelectric scavenger. Transceiver 22, data processor 24, and signal conditioner 26 may, in some instances, be logically separable components formed in or mounted on a single shared circuit board. Power source 30 may provide power to all components on such a shared circuit board. Accelerometer 32 is a two- or three-dimensional accelerometer capable of providing data processor 24 with a signal indicating an orientation of field device 10. This orientation information is used to select an initial antenna configuration for transmission and reception by antennas 20 and transceiver 22, as described in greater detail below with respect to FIGS. 4a and 4b. Accelerometer 32 may in some embodiments be integrated into or mounted on a common circuit board shared with transceiver 22, data processor 24, and/or signal conditioner 26.

Field device 10 may act as a sensor device, collecting process information signals from transducer 28, conditioning those signals at signal conditioner 26, and processing and/or analyzing those signals at data processor 24 before broadcasting process information to remote devices via transceiver 22 and antennas 20. Alternatively, field device 10 may act as an actuator device, commanding transducer 28 via a signal processed and conditioned at data processor 24 and signal conditioner 26, respectively, and received via transceiver 22 and antennas 20. In either case, field device 10 communicates wirelessly with remote devices via antennas 20 and transceivers 22. To conserve power, field device 10 may be configured to power only one antenna 20 (e.g. 20a or 20b) at a time. In some embodiments, transceiver 22 switches between antennas 20 when commanded by data processor 24, so as to maximize received signal strength measured by transceiver 22, as described below with respect to FIGS. 4a and 4b.

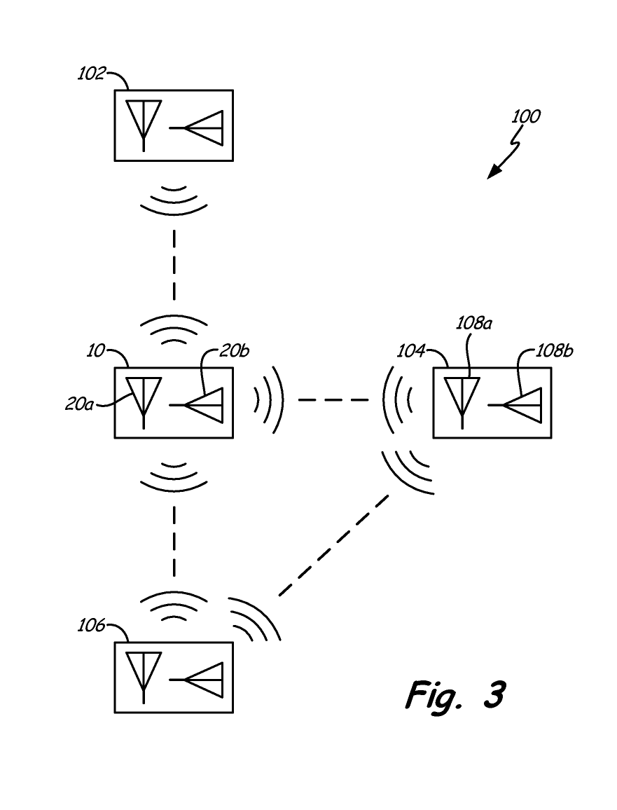

FIG. 3 is a simplified schematic diagram of one embodiment of wireless network 100, comprising a plurality of wireless devices with diversity antenna systems. Wireless network 100 includes field device 10 (with antennas 20a and 20b) and remote devices 102, 104, and 106. Wireless network 100 is intended only as an illustrative example of one possible network configuration; many other network configurations may be utilized without departing from the spirit of the present invention. Remote device 104 is shown with antennas 108a and 108b Like antennas 20a and 20b, antennas 108a and 108b are antennas with diverse angular orientation. Although field device 10 and remote devices 102, 104, and 106 are shown with only two antennas each, any plural number of antennas may be used. In some embodiments, different devices in wireless network 100 may have different numbers of antennas.

Wireless network 100 is depicted as a mesh network wherein field device 10 associates with and communicates via a plurality of other devices in the network (e.g. remote devices 102, 103, and 106). In alternative embodiments, wireless network 100 may be a hub-and-spoke network wherein field device 10 communicates directly with a central wireless hub. Field device 10 communicates with remote device 104 wirelessly via antennas 20a or 20b and 108a or 108b, and communicates analogously with each other connected wireless device (e.g. remote devices 102 and 106). To conserve power, only one antenna of each device is ordinarily powered for each wireless transmission/reception. Thus, the antenna state used to transmit and receive messages between field device 10 and remote device 104 can be described by a link configuration specifying one antenna for field device 10 (i.e. antenna 20a or 20b), and one antenna for remote device 104 (i.e. antenna 108a or 108b). Where wireless device 10 has X antennas, and remote device 104 has Y antennas, a total of X*Y distinct possible link configurations exist, e.g. four configurations 20a-108a, 20a-108b, 20b-108a, and 20b-108b where X=Y=2. Different link configurations may provide stronger or weaker received signal strengths, and may experience greater or lesser degrees of noise. As described below with respect to FIGS. 4a and 4b, field device 10 selects a link configuration to maximize RSSI, minimize packet error rate, and/or minimize noise. Each link configuration is comprised of a local antenna specification (e.g. antenna 20a or 20b) and a remote antenna specification (e.g. antenna 108a or 108b). To ensure optimal signal reception, field device 10 regularly tests all possible link configurations and selects the configuration with the strongest measured RSSI and lowest packet error rate, as described below.

FIGS. 4a and 4b are two possible embodiments of methods for selecting link configurations to maximize RSSI measured at transceiver 22. Each link configuration specifies an antenna of field device 10, and an antenna of field device 104. FIG. 4a depicts method 200a, wherein data processor 24 periodically transmits test packets along all possible link configurations to select the configuration with the strongest RSSI. FIG. 4b depicts method 200b, wherein data processor 24 periodically checks a single alternative link configuration, eventually cycling between all possible link configurations over several periodic intervals. Although methods 200a and 200b focus on the use of RSSI to select link configurations, packet error rate may additionally or alternatively be used.

As described below, both method 200a and method 200b select link configurations according to RSSI at field device 10, as measured by transceiver 22, and are therefore suited only to maximize signal strength received at field device 10. In alternative embodiments, however, methods 200a and 200b may be adapted to utilize remote RSSI information received over antennas 20 and transceiver 22 from remote device 104, either in addition to or instead of RSSI signals from transceiver 22 reflecting signal strength received at field device 10. In this way, methods 200a and 200b may be adapted to maximize received signal strength at field device 10, remote device 108, or both, without departing from the spirit of the invention as described below. In some embodiments, methods 200a and 200b may additionally or alternatively record packet error rates, and select link configurations to minimize packet error rates.

According to method 200a, data processor 24 selects an initial reception antenna from among antennas 20 according to a sensed orientation of field device 10, as measured by accelerometer 32. A substantially vertical or a substantially horizontal antenna 20 may be initially preferred, depending on the particular environment of wireless network 100 and the default settings of other wireless devices in wireless network 100. Remote device 104 initially transmits using a default initial antenna selected from among antennas 108a and 108b. The initial antenna selection for field device 10 and an initial antenna selection of remote device 104 together constitute an initial primary link configuration (PLC). (Step S1a). This initial PLC is one of N=X*Y possible link configurations, where X is the number of antennas 20, and Y is the number of antennas of remote device 104.

According to method 200a, field device 10 and remote device 104 next engage in ordinary transmission and reception of payload messages (e.g. industrial process information as described above with respect to FIGS. 2 and 3) over link configuration PLC. (Step S2a). During ordinary transmission, field device 10 may record the packet error rate of the PLC by counting unreceived messages as a fraction of all messages sent over an extended period (e.g. 15 minutes). Ordinary transmission continues until a time period T elapses. (Step S3a). Data processor 24 may detect the elapse of time period T using a real time clock (not shown in FIG. 2), or using a machine-time counter which increments until a threshold value is reached, indicating the elapse of time period T. During ordinary operation, transceiver 22 monitors RSSI of signals received from remote device 104

Upon the elapse of time period T, processor 24 selects a link configuration other than the current PLC as an alternative link configuration (ALC), and initializes a counter n=1. (Step S4a). Field device 10 then transmits a request for one or more test packets from remote device 14 using the PLC. Test packets may be specialized short messages used solely to test RSSI, packet loss rate, or other signal characteristics of the ALC. Alternatively, test packets may be ordinary payload messages transmitted along the alternative, rather than the primary, link configuration. Each test packet is transmitted and received using the ALC, and transceiver 22 monitors RSSI of these test packets. (Step S5a). In some embodiments, field device 10 may also record the reception or non-reception of each test packet over an extended period (e.g. 15 minutes) to form a measure of packet error rate for the ALC. Packet error rate of both the PLC and one or more ALCs can be reported in periodic health reports.

Processor 24 compares the RSSI of the ALC to the RSSI of the PLC (from ordinary operation). (Step S6a). If the ALC RSSI exceeds the PLC RSSI, the current ALC is set as the new PLC. (Step S7a). In some embodiments the PLC may only be changed if the ALC RSSI exceeds the PLC RSSI by more than a specified amount, to prevent PLC switching due to insignificant fluctuations in signal strength. This process is repeated for all possible link configurations, iterating ALCs and counters n (Step S8a) until all N−1 possible alternative link configurations have been tested (Step S9a). If the testing process of steps S4a through S9a results in a new PLC, this PLC is transmitted to remote device 104 and utilized henceforth for ordinary transmission of payload messages (Step S2a) until the elapse of the next time period T (Step S3a), whereupon the testing process is repeated.

Packet error rate may be used instead or in addition to RSSI when selecting link configurations. In particular, packet error rate may be used as an additional signal criteria that overrides signal strength in determining primary link configuration. If periodic health reports indicate that packet error rates of an ALC are more than a threshold value less than packet error rates of the PLC, the lower-error ALC may replace the PLC.

Method 200b differs slightly from method 200a. As in method 200a, processor 24 initially selects a PLC specifying one of antennas 20 chosen according to the orientation of field device 10, as determined by accelerometer 32. Processor 24 also selects an ALC from among possible alternative link configurations, and sets the counter n=1, as a part of this initial setup. (Step S1b). Field device 10 and remote device 104 then transmit and receive payload messages of process signals as described above with respect to Step S2a, with transceiver 22 monitoring RSSI and aggregate signal error rate of packets received at field device 10. (Step S2b). When time period T between tests elapses (Step S3b), processor 24 requests that one or more messages transmitted and received according to the ALC. (Step S4b). These ALC messages may be test packets or ordinary payload messages as described above with respect to Step S5a of method 200. ALC messages of payload information may replace regularly scheduled PLC messages, may be redundantly sent in addition to PLC messages, to ensure reception of payload information at field device 10. The recorded RSSI of messages transmitted and received using the PLC is compared with the RSSI of messages transmitted and received using the ALC. (Step S5b). If the ALC RSSI exceeds the PLC RSSI, the current ALC is set as the new PLC. (Step S6b). Processor 24 next selects ALC from among possible link configurations, increments counter n (Step S7b), and compares n to the total number of possible alternative link configurations (Step S8b). Steps S2b through S8b are then repeated, and a different ALC is tested with each elapse of time period T. Once all link configurations have been tested, counter n is reset to 1 and the ALC is reset to its initial value, whereupon the entire cycle repeats. (Step S9b).

Method 200a tests all possible ALCs in each time period T. By contrast, method 200b tests only a single ALC with each time period T, and therefore can take as long as (N−1)*T to address all possible link configurations. Each method has its advantages. Method 200a provides more rapid link configuration adjustment to optimize RSSI, which may be particularly useful in changing environments. Because of the lower testing rate of method 200b, however, method 200b is considerably less energy intensive than method 200a.

In addition to the periodic RSSI testing described above, methods 200a and 200b may be adapted to include monitoring for packet error rate (i.e. the ratio of packets sent to packets received). In some embodiments, methods 200a and 200b may be modified to set the ALC as the PLC (Steps S6a or S5b, above) if periodic health reports indicate that PLC packet error rates exceed packet error rates for at least one ALC. To account for emergency failures of the PLC, methods 200a and 200b may be further modified to break from ordinary transmission over the PLC to an ALC for ordinary transmission if the PLC RSSI recorded in steps S2a or S2b drops below an acceptable threshold. Accelerometer 32 provides orientation information used to select a favorable rather than an arbitrary initial link configuration. This initial link configuration is adjusted according to method 200a or 200b to improve the strength and in some instances quality of signal reception at field device 10.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A wireless device comprising:
a plurality of diverse antennas;
an accelerometer configured to provide a signal from which orientation of the wireless device can be determined; and
a processor configured to:
initially select a primary link configuration based on the determined orientation of the wireless device, the primary link configuration designating one or more of the plurality of diverse antennas and one or more antennas of another wireless device configured to transmit the payload messages;
receive payload messages using the primary link configuration, and record a received signal strength indication (RSSI) value for the received payload messages;
periodically test RSSI for alternative link configurations;
compare RSSI between the primary link configuration and the alternative link configuration; and
revise the primary link configuration when the comparison indicates that the alternative link configuration RSSI is greater than primary link configuration RSSI.

2. The wireless device of claim 1, wherein the primary link configuration and the alternative link conditions each designate one or more of the plurality of diverse antennas and one or more of a second plurality of diverse antennas of the other wireless device.

3. The wireless device of claim 1, wherein the processor periodically tests every possible alternative link configuration by exercising each link configuration with a data packet.

4. The wireless device of claim 1, wherein periodically testing alternative link configurations comprises transmitting periodic test packets using the alternative link configurations.

5. The wireless device of claim 1, wherein periodically testing alternative link configurations comprises transmitting payload messages using the primary link configuration, and redundantly transmitting a subset of the payload messages using the alternative link configuration.

6. The wireless device of claim 1, wherein periodically testing alternative link configurations comprises periodically transmitting payload message using the alternative link configuration, rather than the primary link configuration.

7. The wireless device of claim 1, wherein the plurality of antennas are formed on a circuit board.

8. The wireless device of claim 1, wherein the processor is further configured to:
record packet loss rate for the received payload messages;
periodically test packet loss rate for alternative link configurations;
compare packet loss rate between the primary link configuration and the alternative link configuration; and
revise the primary link configuration when the comparison indicates that the alternative link configuration packet loss rate is less than the primary link configuration packet loss rate.

9. The wireless device of claim 1, wherein the processor is configured to revise the primary link configuration only when the comparison indicates that the alternative link configuration RSSI exceeds the primary link configuration RSSI by at least a specified amount.

10. A wireless network comprises:
a first wireless device having a printed wiring board with at least one first antenna; and
a second wireless device having an accelerometer configured to provide a signal from which orientation of the wireless device can be determined, a printed wiring board with a plurality of second antennas with diverse orientations, and a processor configured to:
transmit and receive payload messages between the first wireless device and the second wireless device using a link configuration designating one or more of the first antennas and one or more the second antennas;
initially select a primary link configuration using the determined orientation of the second wireless device;
periodically test an alternative link configuration;
compare received signal parameters between the primary link configuration and the alternative link configuration; and
revise the primary link configuration whenever the comparison indicates that the alternative link configuration is superior to the primary link configuration.

11. The wireless network of claim 10, wherein the first wireless device comprises a plurality of first antennas with diverse orientations.

12. The wireless network of claim 10, wherein comparing received signal parameters comprises comparing received signal strength between the primary link configuration and the alternative link configuration, and wherein the primary link configuration is revised whenever the comparison indicates that the alternative link configuration signal strength exceeds the primary link configuration signal strength.

13. The wireless network of claim 12, wherein the processor is configured to revise the primary link configuration only when the comparison indicates that the alternative link configuration RSSI exceeds the primary link configuration RSSI by at least a specified amount.

14. The wireless network of claim 10, wherein comparing received signal parameters comprises comparing received packet error rate between the primary link configuration and the alternative link configuration, and wherein the primary link configuration is revised whenever the comparison indicates that the primary link configuration packet error rate exceeds the alternative link configuration packet error rate.

15. The wireless network of claim 10, wherein comparing received signal parameters comprises comparing received noise levels between the primary link configuration and the alternative link configuration, and wherein the primary link configuration is revised whenever the comparison indicates that the primary link configuration noise level exceeds the alternative link configuration noise level.

16. The wireless network of claim 10, wherein the processor is configured to periodically enter a test cycle wherein it requests and receive at least one test packet from the first wireless device using each possible alternative link configuration.

17. The wireless network of claim 10, wherein the processor is configured to periodically request and receive a single test message using an alternative link configuration that differs from each single test message to the next.

18. The wireless network of claim 17, wherein the single test message is a test packet.

19. The wireless network of claim 17, wherein the single test message is one of the payload messages.

20. A method for selecting a link configuration designating at least one antenna of a first wireless device and at least one antenna of a second wireless device, the method comprising:
initially selecting a reception antenna of the first wireless device based on an orientation of a first wireless device ascertained using an accelerometer;
receiving payload messages from the second wireless device at the second wireless device using a primary link configuration;
periodically testing one or more alternative link configurations;
comparing a received signal strength indication (RSSI) at the first wireless device between the primary link configuration and the alternative link configuration; and
revising the primary link configuration whenever the comparison indicates that alternative link configuration RSSI exceeds primary link configuration RSSI.

21. The method of claim 20, wherein the each of the primary link configuration and the alternative link configurations designates at least one of a first plurality of diverse antennas of the first wireless device, and at least one of a second plurality of diverse antennas of the second wireless device.

22. The method of claim 20, wherein the primary link configuration is only revised if the comparison indicates that the alternative link configuration RSSI exceeds the alternative link condition RSSI by at least a specified amount.

23. The method of claim 20, wherein periodically testing one or more alternative link configurations comprises periodically entering a test cycle wherein all possible alternative link configurations are tested.

24. The method of claim 20, wherein periodically testing one or more alternative link configurations comprises periodically testing a single alternative link configuration which differs from one periodic test to the next.

25. An industrial process field device comprising:
a casing configured to be mounted in a stationary position;
a transducer housed in the casing and configured to interact with an industrial process;
a plurality of diverse antennas;
an accelerometer configured to provide a signal from which orientation of the casing can be determined; and
a processor configured to:
transmit payload messages using a link configuration designating one or more of the plurality of diverse antennas, and one or more antennas of another wireless device configured to receive the payload messages;
initially select a primary link configuration using the determined orientation of the casing;
periodically test an alternative link configuration;
compare packet error rate and received signal strength between the primary link configuration and the alternative link configuration; and
revise the primary link configuration whenever the comparison indicates that the alternative link configuration is superior to the primary link configuration.

26. The industrial process field device of claim 22, wherein the plurality of diverse antennas are printed on a circuit board in the casing.

27. The industrial process field device of claim 25, wherein the primary link configuration and the alternative link conditions each designate one or more of the plurality of diverse antennas and one or more of a second plurality of diverse antennas of the other wireless device.
